(19) United States
(12) Patent Application Publication
(10) Pub. No.: US 2024/0377281 A1
(43) Pub. Date: Nov. 14, 2024

(54) EQUIPMENT AND METHOD FOR MEASURING CROSSTALK BETWEEN CORES OF AN OPTICAL FIBER HAVING MULTIPLE CORES

(71) Applicant: NIPPON TELEGRAPH AND TELEPHONE CORPORATION, Tokyo (JP)

(72) Inventors: Tomokazu ODA, Musashino-shi, Tokyo (JP); Atsushi NAKAMURA, Musashino-shi, Tokyo (JP); Yusuke KOSHIKIYA, Musashino-shi, Tokyo (JP)

(73) Assignee: NIPPON TELEGRAPH AND TELEPHONE CORPORATION, Tokyo (JP)

(21) Appl. No.: 18/692,981

(22) PCT Filed: Oct. 8, 2021
(86) PCT No.: PCT/JP2021/037323

§ 371 Date: Mar. 18, 2024

(51) Int. Cl. G01M 11/02; G01M 11/00

(52) U.S. Cl. CPC G01M 11/0221; G01M 11/335

(57) ABSTRACT

The present disclosure relates to a method for measuring inter-core crosstalk of an optical fiber having a plurality of cores, the method including: injecting light into one core of the optical fiber; converting light emitted from each of the cores provided in the optical fiber into parallel light with an angle difference; measuring an intensity distribution of an interference waveform of the parallel light; independently obtaining an interference component between the one core and any core, different from the one core, provided in the optical fiber and a DC component other than the interference component using the interference waveform of the parallel light; and obtaining crosstalk from the one core to any core, different from the one core, using the interference component and the DC component.

### TECHNICAL FIELD

The present invention relates to a measuring apparatus and a measuring method thereof, which are capable of obtaining inter-core crosstalk of an optical fiber having a plurality of cores.

### BACKGROUND ART

In recent years, in line with the rapid increase in transmission traffic, in place of a single-mode fiber (SMF) used in current transmission lines, a multi-core fiber (MCF) having a plurality of cores has been attracting a great deal of attention as means of a further increase in capacity. In the transmission using an MCF, it is possible to expand transmission capacity by the number of cores as compared with an SMF in the related art. On the other hand, in an MCF, since inter-core crosstalk (XT) limits the transmission capacity, it is necessary to control XT as much as possible. Also, measurement of generated XT is required to assess whether the XT of an MCF satisfies a desired value.

In order to measure the XT of an MCF, it is necessary to measure the intensity of light emitted from each core and obtain the light intensity ratio between the cores. In order to measure the intensity of light emitted from each core, a power meter method is generally used in which each core of an MCF and an SMF are directly fusion-connected. Although the power meter method has an advantage of a simple structure, it is necessary to perform alignment and connection as many times as the number of cores, and thus the measurement takes time. Therefore, a technique capable of eliminating the need for connection between each core of the MCF and the SMF is desirable.

As a technique for eliminating the need for connection between each core of an MCF and an SMF, a method for measuring emitted light from an MCF by means of an image sensor and obtaining XT from the intensity thereof has been proposed (NPL 1). In this technique, an image of light emitted from an MCF is formed by a magnifying optical system, and the image is measured by an image sensor to independently measure the electric field intensity distribution in each core. Thus, the XT can be measured without connecting to a fiber or the like.

On the other hand, in an image sensor, sensitivity may differ in each pixel in the sensor, and even when the intensity of light emitted from each core is the same, the light intensity acquired by the image sensor may vary. Therefore, it is necessary to correct the difference in sensitivity among the pixels.

Since the minimum measurable XT depends on the dynamic range of the image sensor, in NPL 1, the end face of the reference core is physically masked with a light shielding tape after measurement of the intensity of signal light from the reference core, and then light emitted from the other cores is measured. Therefore, there is problem that the measurement of XT is not easy even in NPL 1.

### CITATION LIST

### Non Patent Literature

[NPL 1] S. Saitoh, Y. Amma, Y. Sasaki, K. Takenaga, and K. Aikawa, “Improved Method for Measuring Inter-Core Crosstalk in Multi-Core Fibres Using a Near-Infrared Camera”, in 2016 European Conference on Optical Communication (ECOC) p 728 (2016).

### SUMMARY OF INVENTION

### Technical Problem

An object of the present disclosure is to provide a technique through which XT of a fiber having a plurality of cores can be easily measured.

### Solution to Problem

In the present disclosure, interference light, emitted from a fiber having a plurality of cores, of each of the cores is measured. Inter-core XT can be obtained by analyzing this interference light.

Specifically, an apparatus for measuring inter-core crosstalk according to the present disclosure includes:
means for injecting a laser beam into one core of an optical fiber having a plurality of cores;
means for converting light emitted from each of the cores provided in the optical fiber into parallel light with an angle difference;
electric field intensity distribution measuring means capable of measuring an intensity distribution of an interference waveform of the parallel light;
interference waveform analysis means capable of independently obtaining an interference component between the one core and any core, different from the one core, provided in the optical fiber and a DC component other than the interference component using the measured intensity distribution of the interference waveform; and
crosstalk analysis means capable of obtaining crosstalk from the one core to any core, different from the one core, using the interference component and the DC component.

Specifically, a method for measuring inter-core crosstalk according to the present disclosure is
a method for measuring inter-core crosstalk of an optical fiber having a plurality of cores, the method including:
injecting light into one core of the optical fiber;
converting light emitted from each of the cores provided in the optical fiber into parallel light with an angle difference;
measuring an intensity distribution of an interference waveform of the parallel light;
independently obtaining an interference component between the one core and any core, different from the one core, provided in the optical fiber and a DC component other than the interference component using the interference waveform of the parallel light; and
obtaining crosstalk from the one core to any core, different from the one core, using the interference component and the DC component.

### Advantageous Effects of Invention

In the present disclosure, XT of a fiber having a plurality of cores can be obtained without connecting the optical fibers and without masking the end face of the reference core. Therefore, according to the present disclosure, XT of a fiber having a plurality of cores can be easily measured.

### BRIEF DESCRIPTION OF DRAWINGS

FIG. 1 illustrates an example of a measuring apparatus according to the present embodiment.

FIG. 2A illustrates an example of emitted light from a core C1 of an optical fiber under test.

FIG. 2B illustrates an example of emitted light from a core C2 of an optical fiber under test.

FIG. 3 illustrates a measurement example of an electric field intensity distribution of emitted light.

FIG. 4 illustrates an example of observed interference fringes.

FIG. 5 illustrates an example of a two-dimensional spatial frequency spectrum.

FIG. 6 illustrates an example of a measuring method according to the present embodiment.

### DESCRIPTION OF EMBODIMENTS

Embodiments of the present disclosure will be described hereinafter in detail with reference to the drawings. It is to be understood that the present disclosure is not limited to the embodiments described below. The embodiments are merely exemplary and the present disclosure can be implemented in various modified and improved modes based on knowledge of those skilled in the art. Constituent elements with the same reference signs in the present specification and in the drawings represent the same constituent elements.

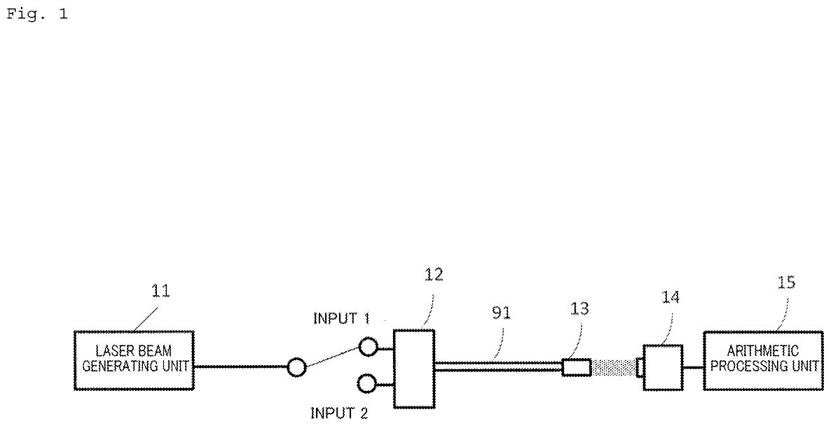

FIG. 1 illustrates an example for implementing the present disclosure. A measuring apparatus according to the present embodiment includes a laser beam generating unit 11, an input core selecting unit 12, a collimator 13, an electric field intensity distribution measuring unit 14, and an arithmetic processing unit 15. The measuring apparatus according to the present embodiment executes a method for measuring inter-core crosstalk of an optical fiber 91 under test having a plurality of cores by using these configurations.

The laser beam generating unit 11 and the input core selecting unit 12 function as means for injecting a laser beam into one core of the optical fiber 91 under test.

The collimator 13 functions as means for converting light emitted from each core provided in the optical fiber 91 under test into parallel light with an angle difference.

The electric field intensity distribution measuring unit 14 functions as electric field intensity distribution measuring means capable of measuring the intensity distribution of the interference waveform of the parallel light.

The arithmetic processing unit 15 functions as interference waveform analysis means and crosstalk analysis means.

The interference waveform analysis means independently obtains an interference component between the one core and any core, different from the one core, provided in the optical fiber 91 under test and a DC component other than the interference component using the measured intensity distribution of the interference waveform.

The crosstalk analysis means obtains crosstalk from the one core to any core, different from the one core, using the interference component and the DC component.

The arithmetic processing unit 15 can also be implemented on a computer and in a program, and the program can be recorded in a recording medium or provided through a network. A program according to the present disclosure is a program for instructing a computer to implement functions of the device according to the present disclosure, and is a program for instructing a computer to execute steps of the method executed by the device according to the present disclosure.

A coherent laser beam generated by the laser beam generating unit 11 may be injected into any core of the optical fiber 91 under test. Here, since the measuring apparatus according to the present embodiment includes the input core selecting unit 12, the light can be injected into a desired core of the optical fiber 19 under test. The light emitted from the optical fiber 91 under test passes through the collimator 13 such as a collimating lens and is then emitted into a space.

Here, the collimator 13 may be any lens capable of converting the emitted light into parallel light, and a general-purpose lens for collimating light emitted from the general-purpose SMF having one core at the center thereof can be used. By disposing the collimator 13 at the emitting end of the optical fiber 91 under test, an angle difference is generated in the light emitted from each core.

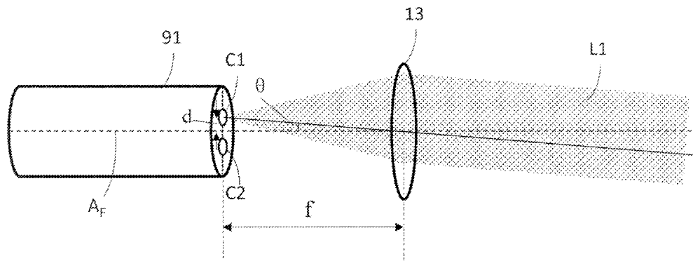

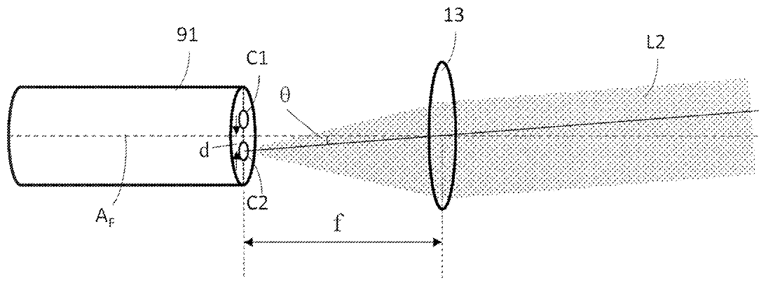

FIGS. 2A and 2B illustrate examples of light emitted from each core of the optical fiber 91 under test. As illustrated in FIGS. 2A and 2B, since cores C1 and C2 are disposed at positions deviated by distance d from a central axis A_{F} of the fiber 91 under test, an angle difference corresponding to amounts of deviation d from the central axis A_{F} to the cores C1 and C2 and a focal distance f of the collimator 13 is generated in emitted light beams L1 and L2 from the cores C1 and C2 passing through the collimator 13. Here, in FIGS. 2A and 2B, in light of a component in which the emitted light beams L1 and L2 from the cores C1 and C2 pass through the center of the lens of the collimator 13, an angle difference 2θ between the emitted light beams L1 and L2 from the collimator 13 has the following relationship.

$$\begin{matrix}[ Math . 1 ] & \\ 2 θ = 2 {tan}^{- 1} \frac{d}{f} & ( 1 )\end{matrix}$$

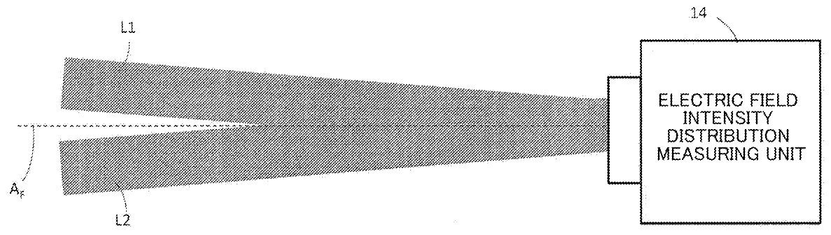

The respective emitted light beams L1 and L2 from the collimator 13 are measured by the electric field intensity distribution measuring unit 14 such as an image sensor. FIG. 3 illustrates the measurement of the electric field intensity distribution of emitted light. FIG. 3 illustrates a state in which the emitted light beams L1 and L2 from the cores C1 and C2 overlap each other with an angle difference, and this intensity distribution is measured on the light-receiving surface of the electric field intensity distribution measuring unit 14. Here, since the emitted light beams L1 and L2 from the cores C1 and C2 are coherent laser beams, the intensity waveforms of the interference fringes of the emitted light beams L1 and L2 can be measured in the electric field intensity distribution measuring unit 14.

Although FIG. 2 illustrates an example in which the amounts of deviation d from the central axis A_{F} to the cores C1 and C2 are equal, the present disclosure is not limited thereto. FIG. 3 illustrates an example in which the optical axis of the collimator 13 coincides with the central axis A_{F} of the fiber 91 under test and the light-receiving surface of the electric field intensity distribution measuring unit 14 is disposed on the central axis A_{F} of the fiber 91 under test, but the present disclosure is not limited thereto.

It is assumed that the optical fiber 91 under test is a four-core fiber having cores C1, C2, C3, and C4, and that the input core selecting unit 12 injects a laser beam only into the core C1. At the emitting end of the four-core fiber, an XT component from the core C1 is emitted from the cores C2, C3, and C4 in addition to the emitted light from the core C1, interference fringes of emitted light beams L1, L2, L3 and L4 are measured.

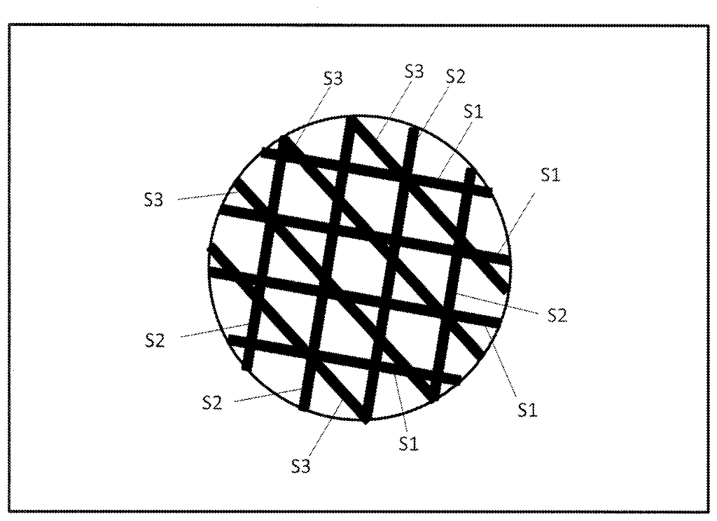

FIG. 4 illustrates an example of interference fringes observed by the electric field intensity distribution measuring unit 14. FIG. 4 illustrates a state in which the emitted light beams L1, L2, L3, and L4 from the cores C1, C2, C3, and C4 are all present in the same black solid line shape in an observation region in the electric field intensity distribution measuring unit 14, and they are measured in an overlapped state.

In the present disclosure, since the emitted light beams L1, L2, L3, and L4 overlap each other, interference fringes S1, S2, and S3 corresponding to the angle differences between the respective emitted light beams L1, L2, L3, and L4 can be measured. An intensity waveform I of the measured interference fringes S1, S2, and S3 can be expressed by the following equation.

$$\begin{matrix}[ Math . 2 ] & \\ \begin{matrix}I = {\vert {E}_{1} + {E}_{2} + {E}_{3} + {E}_{4} \vert}^{2} \\ \approx {\vert {A}_{1} \vert}^{2} + 2 {A}_{1} {A}_{2} cos ( {ϕ}_{1} - {ϕ}_{2} ) + 2 {A}_{1} {A}_{3} cos ( {ϕ}_{1} - {ϕ}_{3} ) + 2 {A}_{1} {A}_{4} cos ( {ϕ}_{1} - {ϕ}_{4} )\end{matrix} & ( 2 )\end{matrix}$$

Here, E₁, E₂, E₃, and E₄ are electric field complex amplitudes of emitted light from the cores C1, C2, C3, and C4. Also, A₁, A₂, A₃, and A₄ and φ₁, φ₂, φ₃, and φ₄ are the amplitudes and initial phases of E₁, E₂, E₃, and E₄, respectively. Since E₂, E₃, and E₄ are XT components, their DC components and interference components are negligible, and only the DC component of E₁ and interference components with E₁ are observed.

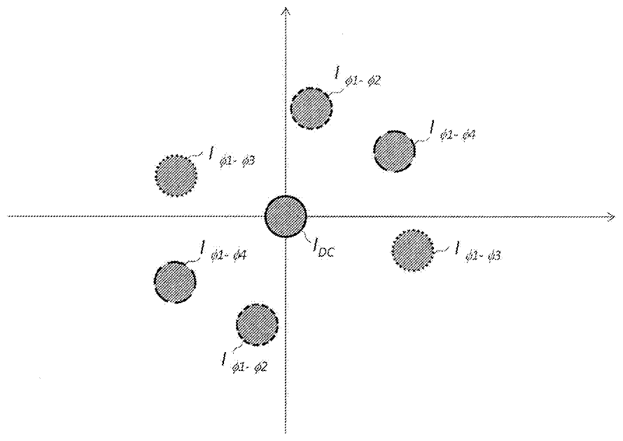

By performing a two-dimensional Fourier transform on the intensity waveform, a two-dimensional spatial frequency spectrum as illustrated in FIG. 5 can be obtained. At the origin of this spectrum, I_{DC}, which is the component of the first term of Equation (2), is present, and I_{φ1-φ2}, I_{φ1-φ3}, and I_{φ1-φ4}, which are the components of the second, third, and fourth terms, are present at positions, shifted from the origin, depending on the angle difference in Equation (1), respectively. The I_{DC}, I_{φ1-φ2}, I_{φ1-φ3}, and I_{φ1-φ4} components obtained from this spatial frequency spectrum are extracted by band-pass filters.

Assuming that XT from the core C1 to the cores C2, C3, and C4 are XT₁₋₂, XT₁₋₃, and XT₁₋₄, respectively, the following equations can be obtained using the extracted I_{DC}, I_{φ1-φ2}, I_{φ1-φ3}, and I_{φ1-φ4}.

$$\begin{matrix}[ Math . 3 ] & \\ \begin{matrix}{XT}_{1 - 2} = 10 {{log}_{10} ( \frac{{I}_{ϕ1 - ϕ2}}{2 {I}_{DC}} )}^{2} \\ = 10 {log}_{10} ( \frac{{A}_{1} {A}_{2}}{{{A}_{1} \vert}^{2}} ) \\ = 10 {log}_{10} ( \frac{{P}_{2}}{{P}_{1}} )\end{matrix} & ( 3 )\end{matrix}$$

$$\begin{matrix}[ Math . 4 ] & \\ \begin{matrix}{XT}_{1 - 3} = 10 {{log}_{10} ( \frac{{I}_{ϕ1} - {I}_{ϕ3}}{2 {I}_{DC}} )}^{2} \\ = 10 {log}_{10} ( \frac{{P}_{3}}{{P}_{1}} )\end{matrix} & ( 4 )\end{matrix}$$

$$\begin{matrix}[ Math . 5 ] & \\ \begin{matrix}{XT}_{1 - 4} = 10 {{log}_{10} ( \frac{{I}_{ϕ1} - {I}_{4}}{2 {I}_{DC}} )}^{2} \\ = 10 {log}_{10} ( \frac{{P}_{4}}{{P}_{1}} )\end{matrix} & ( 5 )\end{matrix}$$

Here, P₁, P₂, P₃, and P₄ are optical powers of emitted light from the core C1, the core C2, the core C3, and the core C4, respectively. From Equations (3) to (5), the inter-core XT from the core C1 can be obtained from the measured intensity waveform of the interference fringes.

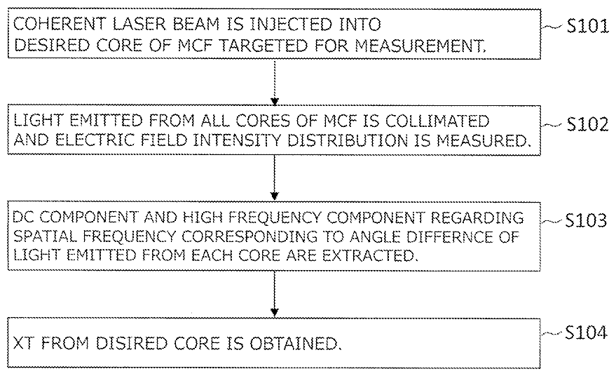

Therefore, the present disclosure measures the inter-core XT of the MCF by executing the measurement procedure illustrated in FIG. 6 using the configuration illustrated in FIG. 1.

S101. A coherent laser beam is injected into a desired core of the MCF targeted for measurement.

S102. The light emitted from all the cores of the MCF is collimated and the electric field intensity distribution is measured.

S103. By performing a Fourier transform on the measured electric field intensity distribution, a DC component and a high frequency component regarding a spatial frequency corresponding to the angle difference of the light emitted from each core are extracted.

S104. XT from the desired core is obtained using the extracted components.

As described above, according to the present disclosure, by the optical axes of the light beams emitted from all the cores provided in the multi-core optical fiber targeted for measurement designed to have angles, different from each other, with respect to the light-receiving surface of the electric field intensity distribution measuring unit 14, the crosstalk from the core on which the light is injected into each of the other cores can be obtained using the interference intensity waveform of the light emitted from the multi-core optical fiber. Therefore, the present disclosure can easily measure inter-core crosstalk without performing fiber connection.

In the above embodiment, examples of a two-core optical fiber and a four-core optical fiber in which no core is disposed on the central axis of the optical fiber 91 under test are illustrated, but the present disclosure is not limited thereto. In the optical fiber 91 under test of the present disclosure, a core may be disposed on the central axis. In this circumstance, the collimator 13 converts the light emitted from the core disposed at the center of the optical fiber 91 under test into parallel light parallel to the central axis of the optical fiber 91 under test. Thus, the optical axes of the light beams emitted from all the cores provided in the optical fiber 91 under test can be designed to have different angles from each other.

### INDUSTRIAL APPLICABILITY

The present disclosure is applicable to information and communication industries.

### REFERENCE SIGNS LIST

11 Laser beam generating unit
12 Input core selecting unit
13 Collimator
14 Electric field intensity distribution measuring unit
15 Arithmetic processing unit
91 Optical fiber under test

1. An apparatus for measuring inter-core crosstalk comprising:
means for injecting a laser beam into one core of an optical fiber having a plurality of cores;
means for converting light emitted from each of the cores provided in the optical fiber into parallel light with an angle difference;
electric field intensity distribution measuring means capable of measuring an intensity distribution of an interference waveform of the parallel light;
interference waveform analysis means capable of independently obtaining an interference component between the one core and any core, different from the one core, provided in the optical fiber and a DC component other than the interference component using the measured intensity distribution of the interference waveform; and
crosstalk analysis means capable of obtaining crosstalk from the one core to any core, different from the one core, using the interference component and the DC component.

2. The apparatus for measuring inter-core crosstalk according to claim 1, further comprising: means for converting light emitted from a core disposed at a center of the optical fiber into parallel light parallel to a central axis of the optical fiber.

3. The apparatus for measuring inter-core crosstalk according to claim 1, wherein the interference waveform analysis means obtains a two-dimensional spatial frequency spectrum from the interference waveform, and
obtains the interference component and the DC component by extracting a frequency component obtained from the two-dimensional spatial frequency spectrum.

4. The apparatus for measuring inter-core crosstalk according to claim 3, wherein the interference waveform analysis means
obtains the DC component by extracting a frequency component, located at an origin, obtained from the two-dimensional spatial frequency spectrum, and
obtains the interference component by extracting a frequency component, located at a position other than the origin, obtained from the two-dimensional spatial frequency spectrum.

5. The apparatus for measuring inter-core crosstalk according to claim 3, wherein the interference waveform analysis means obtains a two-dimensional spatial frequency spectrum by performing a two-dimensional Fourier transform on the interference waveform.

6. A method for measuring inter-core crosstalk of an optical fiber having a plurality of cores, the method comprising:
injecting light into one core of the optical fiber;
converting light emitted from each of the cores provided in the optical fiber into parallel light with an angle difference;
measuring an intensity distribution of an interference waveform of the parallel light;
independently obtaining an interference component between the one core and any core, different from the one core, provided in the optical fiber and a DC component other than the interference component using the interference waveform of the parallel light; and
obtaining crosstalk from the one core to any core, different from the one core, using the interference component and the DC component.

7. The method for measuring inter-core crosstalk according to claim 6, further comprising: converting light emitted from a core disposed at a center of the optical fiber into parallel light parallel to a central axis of the optical fiber.
